(19) United States
(12) Patent Application Publication
(10) Pub. No.: US 2006/0064473 A1
(43) Pub. Date: Mar. 23, 2006

(54) Method and apparatus to facilitate inter-domain presence services

(75) Inventors: Michael Borella, Naperville, IL (US); Guanglu Wang, Kildeer, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 10/946,145

(22) Filed: Sep. 21, 2004

(51) Int. Cl. G06F 15/177

(52) U.S. Cl. 709/220

(57) ABSTRACT

A first presence server as comprises a part of a first communications domain and a second presence server as comprises a part of a second communications domain are configured and arranged to communicate presence information regarding the respective client devices of their respective communications domains. Pursuant to one approach, session initiation protocol messaging facilitates such an exchange of presence information. Pursuant to one embodiment, inter-domain presence information can be cached at a receiving presence server to permit subsequent use when responding to a local request for inter-domain presence information.

### TECHNICAL FIELD

This invention relates generally to communications between communications domains and more particularly to presence information and services.

### BACKGROUND

Presence services are known in the art. Presence relates generally to the location and/or logical or operational status of a given entity such as a mobile node or other device, a specific user, or even a particular application. (As used herein, presence (i.e., the presence of and information regarding a given entity on a network), availability (i.e., the programmed, operational, and/or authorized availability of a given entity to participate in a particular type of communication session or transaction), and location (i.e., the geographical and/or network physical and/or virtual location of a given entity) are all understood to comprise “presence” information.) Presence information has various uses including the facilitation of intelligent decision-making about when, where, and how to deliver information to a given entity.

In general, a participating entity (such as a mobile node) publishes presence information regarding itself via communications on its network (with session initiation protocol often serving as the communication vector of choice). A corresponding presence server receives and stores that presence information. Other network entities (often referred to as watchers in this context) then subscribe to the presence server for access to such information. The presence server notifies such subscribers of presence updates pursuant to an update and response strategy of choice.

Though initially deployed in relatively isolated settings (i.e., within a given communications domain), the value and benefit of presence information in other more widely distributed settings (such as push-to-talk applications) is clear. Unfortunately, numerous impediments exist to effecting large-scale presence service. As one example, presence information must likely be shared across multiple independent communications domains (as arranged, operated, or otherwise managed and administered by multiple independent companies and service providers). A single centralized presence server farm or other repository will not likely adequately meet such a demand as necessary information (such as user and profile content) is often owned and controlled within such a communication domain by such an operator or provider. The quantity of presence traffic between such regions to support corresponding communications regarding updates, subscriptions, and notifications must also be minimized as possible to conserve bandwidth.

### BRIEF DESCRIPTION OF THE DRAWINGS

The above needs are at least partially met through provision of the method and apparatus to facilitate inter-domain presence services described in the following detailed description, particularly when studied in conjunction with the drawings, wherein:

FIG. 1 comprises a block diagram of a presence server as configured in accordance with various embodiments of the invention;

FIG. 2 comprises a block diagram of a multi-domain system as configured in accordance with various embodiments of the invention;

FIG. 3 comprises a flow diagram as configured in accordance with various embodiments of the invention;

FIG. 4 comprises a signal flow diagram illustrating presence publication as configured in accordance with various embodiments of the invention; and

FIG. 5 comprises a signal flow diagram illustrating presence subscription as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, presence servers as comprise parts of differing communications domains are arranged and configured to communicate between themselves presence information regarding client devices of their respective communications domains. This presence information can comprise SUBSCRIBE messages and NOTIFY messages in a preferred approach. Such messages can be communicated using session initiation protocol and may, if desired, be facilitated via a session initiation protocol proxy.

Pursuant to one approach, presence information regarding one or more client devices of a remote communications domain can be cached upon receipt by such a presence server and used thereafter to respond to local presence inquiries. In a preferred approach such information, when cached, is automatically cleared in response to a predetermined event such as receipt of updated presence information and/or detection of the expiration of a corresponding time window.

So configured, sufficient presence information can be timely provided to thereby facilitate useful presence services in extended communications paradigms while also avoiding, for example, a need to share user profiles, buddy lists, or the like between different communication domains.

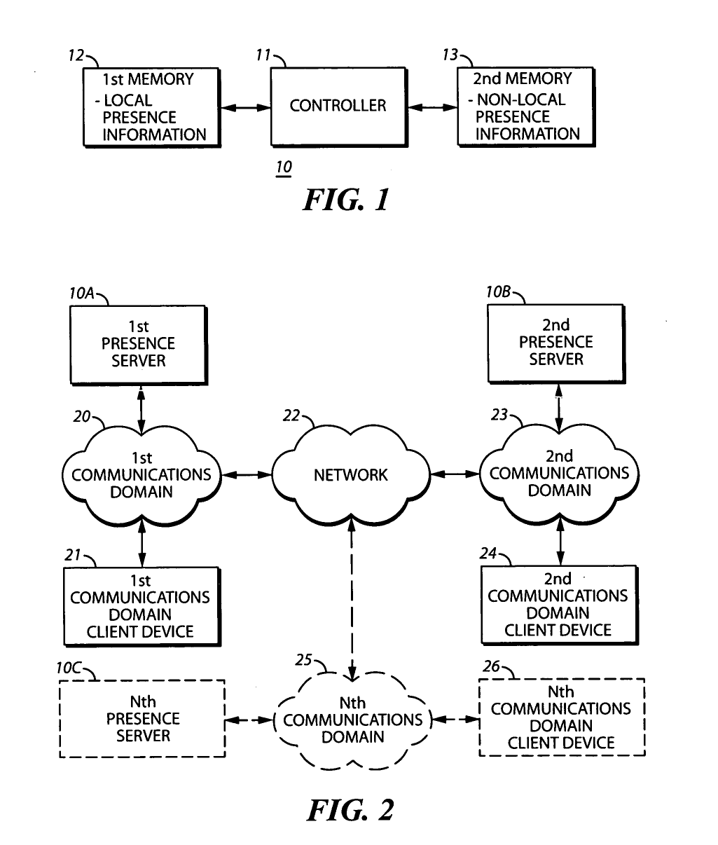

These and other benefits may become clearer upon making a thorough review and study of the following detailed description. Referring now to the drawings, and in particular to FIG. 1, relevant portions of a presence server 10 comprise a controller 11 that operably couples to a first memory 12 and a second memory 13. Pursuant to a preferred approach, the first memory 12 stores presence information regarding local communications domain client devices while the second memory 13 stores presence information regarding at least one non-local communications domain client device. Those skilled in the art will recognize that a presence server typically comprises a wholly or partially programmable platform that can be readily configured to serve as the controller 11. If desired, however, the controller 11 can be embodied as a stand-alone or otherwise dedicated mechanism. It will also be understood that the first and second memories 12 and 13 can comprise separate physical entities, but, if desired, can share a common platform or can be further parsed and segregated using a distributed storage architecture. Such configuration options are well understood in the art and require no further elaboration here.

In a preferred approach, and as will be described in more detail below, the non-local communications domain client device presence information stored in the second memory 13 comprises presence information as was received by the presence server 10 from a non-local presence server (not shown) (for example, presence information as corresponds to a received NOTIFY message). To facilitate such results, the controller 11 is preferably configured and arranged to direct SUBSCRIBE messages to a non-local presence server as comprises a part of a non-local communications domain wherein the SUBSCRIBE message identifies a non-local communication domain client device. Such a controller 11 is further preferably configured to facilitate receipt of a NOTIFY message from such a non-local presence server regarding the non-local communications domain client device and further to receive SUBSCRIBE messages from a local communications domain client device regarding such a non-local communications domain client device.

As will also be elaborated upon below, such a controller 11 is further preferably configured and arranged to automatically store and clear the presence information in response to at least one predetermined event (such as, but not limited to, receipt of updated presence information regarding the non-local communication domain client device, detection of expiration of a time window as corresponds to the presence information, and the like). So configured, the controller 11 is also preferably configured and arranged to facilitate use of such stored presence information to respond to a locally-sourced presence inquiry regarding such a non-local communication domain client device, thereby obviating a need to burden the intervening network with corresponding inquiry and response traffic.

Referring now to FIG. 2, such a presence server 10A (or such other presence server as will serve to suit and support these teachings) can comprise a part of a first communications domain 20 (which may comprise, at least in part, a wireless network) that supports the communications needs of one or more corresponding client devices 21 (only one such device 21 is depicted in this illustration for purposes of clarity, but it will be understood that a given system will typically support hundreds, thousands, or even millions of such devices). It will be understood that such a client device 21 may couple to the first communications domain 20 via a wired and/or via a wireless link in accordance with well-understood prior art technique in this regard. So configured, and in accord with existing knowledge, this first presence server 10A can support presence services for client devices as comprise a part of the first communications domain 20.

In this embodiment, this first communications domain 20 operably couples to a network 22 that typically comprises an extranet such as the Internet. This network 22, in turn, couples to a second communications domain 23 that is at least partially different from the first communications domain 20 (for example, the domains can differ with respect to their domain names, operators, controlling business entities, and the like). In accord with present practice, this second communications domain 23 has its own corresponding second presence server 10B that provides local presence services for corresponding second communications domain client devices 24 (with only one such device 24 being illustrated for purposes of clarity). Pursuant to a preferred implementation of these teachings, and again as elaborated upon in more detail below, the first presence server 10A and the second presence server 10B are arranged and configured to communicate presence information regarding client devices of their respective communication domains between each other. Such communications are preferably, but not necessarily, facilitated using session initiation protocol (SIP). This, in turn, readily permits presence information regarding one of the client devices in one of the communications domains to be automatically provided to another of the client devices in another of the communications domains via their own corresponding presence server.

It will be understood that such teachings are not limited to an exchange of presence information as between only two such communications domains. Instead, any number of such communications domains can be similarly supported as illustrated by optional inclusion of up to an Nth communications domain 25 that again has its own local presence server 10C serving the local presence services needs of a corresponding population of Nth communications domain client devices 26.

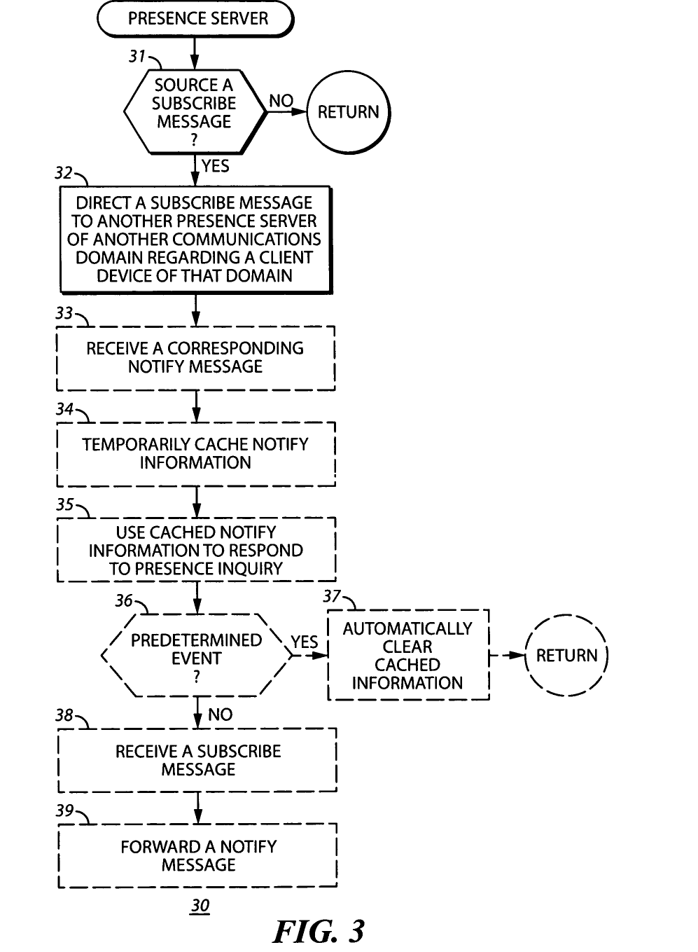

Referring now to FIG. 3, a process 30 to facilitate such inter-domain presence services will be described. Pursuant to this process 30, when a presence server determines 31 a need to source a SUBSCRIBE message as regards a client device of another communications domain, that presence server directs 32 a SUBSCRIBE message regarding that client device to a presence server that comprises a part of that other communications domain (such a need may correspond to receipt of a SUBSCRIBE message from a client device, for example). Pursuant to a preferred approach the presence server uses session initiation protocol to facilitate and bear this SUBSCRIBE message. Depending upon the architectural configuration of the available network fabric, such a message may be directed via a session initiation protocol server as comprises a part of the original communications domain in general accord with present practice. In a similar fashion, a session initiation protocol server as comprises a part of the other communications domain can also comprise a part of the SUBSCRIBE message pathway.

In a preferred, though not required step, the presence server then receives 33 a NOTIFY message from the other presence server, which NOTIFY message comprises presence information regarding the client device identified in the SUBSCRIBE message. The presence server for the other communications domain (such as, for example, the presence server that receives the SUBSCRIBE message) preferably comprises the network entity that sources this NOTIFY message. Upon receipt, the original presence server can then use the presence information as desired.

As one optional illustrative example, the presence server can temporarily cache 34 at least a portion of the NOTIFY message to thereby provide cached information regarding presence of the corresponding client device. This cached information can then be used 35 by the presence server to respond, for example, to a local (or non-local) inquiry regarding this particular client device, notwithstanding that this client device does not comprise a part of this presence server's communication domain.

When caching presence information, it may also be desirable to detect 36 when one or more predetermined events occur and respond accordingly by automatically clearing 37 the cached information. Various predetermined events can provide a useful trigger including but not limited to receiving an updated presence communication regarding the client device, detecting expiration of a time window as corresponds to the cached information (which time window can have a static duration or can vary dynamically as appropriate to the needs of a given application), and the like.

So configured, a presence server can obtain presence information regarding external-domain client devices. In a preferred but optional embellishment, such a process 30 may also support receipt 38 of SUBSCRIBE requests as may be entered by client devices of its own domain regarding foreign domain client devices. This, in turn, preferably leads to the forwarding 39 of at least a portion of a NOTIFY message as was received 33 earlier to the requesting network element.

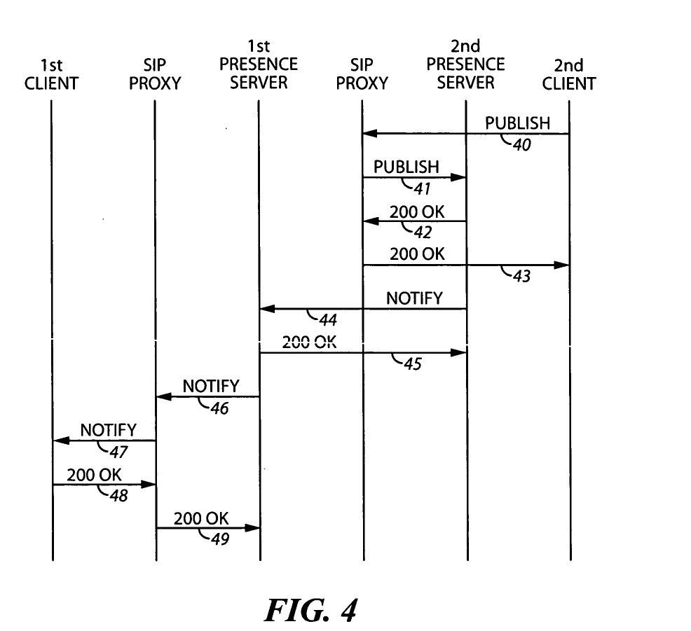

So configured and arranged, such presence servers can readily support the provision and use of presence information as between distinct communications domains. As one illustration, and referring now to FIG. 4, in one communications domain a given client device can transmit a standard PUBLISH message 40 to a session initiation protocol (SIP) proxy for that domain. That SIP proxy, in turn, then forwards a corresponding PUBLISH message 41 to presence server for that communications domain. The latter then replies with an SIP 200 OK message 42 that the SIP proxy forwards on 43 to the given client device.

When a presence server for another communications domain has earlier subscribed to presence information for that client device (for example, as described above), the presence server for the first mentioned communications domain can automatically source a NOTIFY message 44 that bears the published presence information for the client device to the presence server for the another communications domain. After the latter acknowledges the NOTIFY message with a 200 OK message 45, this presence server can then transmit a corresponding NOTIFY message 46, via an intervening SIP proxy 47, to a recipient client device in the communications domain for that presence server. This recipient client device can then acknowledge receipt of that NOTIFY message using 200 OK messages 48 and 49.

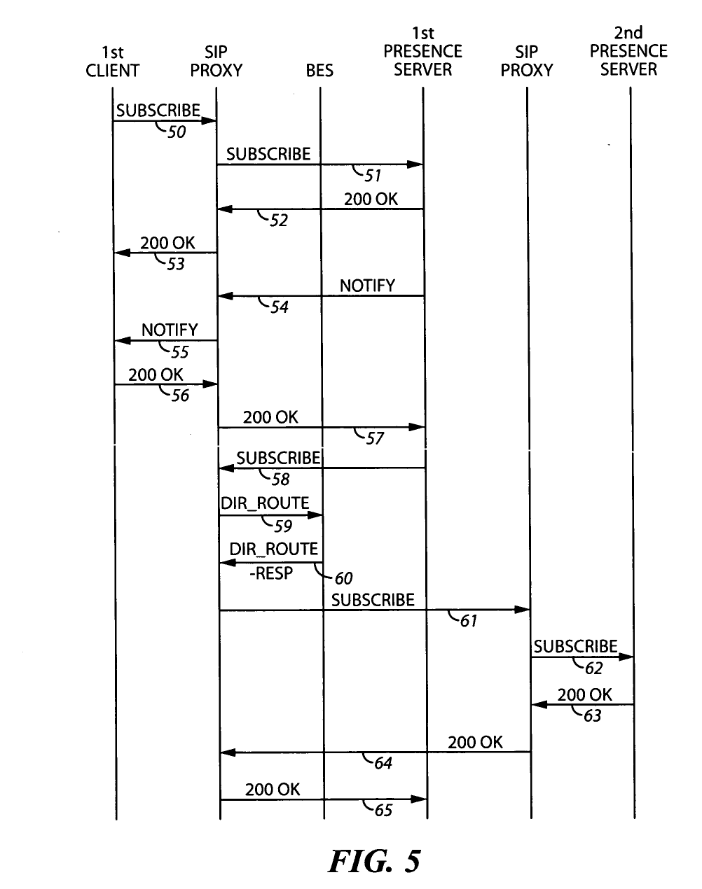

The above illustrative example presupposes that the so-called first client device has already subscribed to presence information for the so-called second client device as comprises an element of a different communication domain from that which services the first client device. Such status can be conferred in various ways. Referring now to FIG. 5, one illustrative example will be described.

In this example, a first client device as is serviced by a first communications domain transmits a standard SUBSCRIBE message 50 to an SIP proxy which, in turn, forwards a corresponding SUBSCRIBE message 51 to a first presence server that provides presence services for that first communications domain. In this example, these SUBSCRIBE messages identify a client device that is serviced by a second, different communications domain. This first presence server can acknowledge this subscription request with an SIP 200 OK message 52 (which can in turn be relayed 53 by an SIP proxy when present and utilized).

As noted above, notwithstanding that the target client device for which presence information is sought may comprise a member of an alien communications domain, the first presence server may nevertheless have cached presence information regarding that target client device available. When true, the first presence server can respond to such a SUBSCRIBE request with a corresponding NOTIFY message 54 (which again may be relayed 55 via an SIP proxy when available and utilized) that contains the relevant cached presence information. The requesting client device can respond to such a NOTIFY message with corresponding SIP 200 OK messages 56 and 57 (again in accord with well understood practice in this regard).

In other instances such presence information may not already be cached at the first presence server (and/or the first presence server may elect to seek an update of such presence information). In such a case the first presence server can transmit a corresponding SUBSCRIBE message 58 to an SIP proxy for the first communications domain. The latter can then transmit a DIR_ROUTE inquiry 59 to an available back end server (which comprises, as is known in the art, one or more databases often accessed by SIP proxies to ascertain configuration information for other SIP devices such as proxies and presence servers) with the latter then returning a DIR_ROUTE_RESP message 60 that provides routing information that the SIP proxy can use to appropriately direct the SUBSCRIBE message 61.

In this example, an SIP proxy for the second communications domain receives the SUBSCRIBE message 61 and relays a corresponding SUBSCRIBE message 62 to a second presence server as comprises a part of the second communications domain. The latter can then acknowledge with a 200 OK message 63 (which in turn can be relayed 64 and 65 via the SIP proxies to the first presence server).

Through this series of messages and actions the first presence server effectively becomes a subscriber to presence information for one or more client devices that are serviced by the second communications domain. This, in turn, can facilitate subsequent receipt of corresponding subscription information as was described above with respect to FIG. 4.

The informed reader will note that the above illustrative examples incorporate SIP proxies into the message flow. Having one or more SIP proxies in such domains will typically allow for a more flexible inter-domain configuration, in part because only the SIP proxies may then need to be provisioned with knowledge of elements in domains other than their own. These same readers will also appreciate, however, that these exemplary call flows are not dependent upon the existence or use of such SIP proxies. In fact, the call flows would be largely the same in their absence.

Those skilled in the art will also recognize that PUBLISH, NOTIFY, and SUBSCRIBE SIP messages comprise well-understood concepts and messages. For the interested reader, additional details regarding such messages can be found in EETF RFC 3265, IETF draft draft-ietf-simple-presence-10.txt, and IETF draft draft-ietf-sip-publish-03.txt, the contents of which are fully incorporated herein by this reference.

So configured, those skilled in the art will readily appreciate that presence information as regards client devices of one communications domain is effectively and efficiently communicated to another domain using essentially standard communications protocols. At the same time, this inter-domain presence service can be facilitated and controlled on a regional/domain-based/operator-based basis. For example, each domain can control its own subscriber database. A user in, say, domain_one.com can add users from domain_two.com, domain_three.com, and domain_four.com to their buddy list and inter-domain presence information can be readily exchanged to support the ordinary functionality of a buddy list without requiring a concurrent surrender of control over the fundamental data that constitutes the buddy list service in a given domain. This accommodation of decoupled subscriber databases in different domains well matches a perceived need for local control while still assuring availability of inter-domain presence information.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. An apparatus to facilitate inter-domain presence services comprising:
a first presence server comprising a part of a first communications domain;
a second presence server comprising a part of a second communication domain, which second communications domain is at least partially different from the first communications domain;
wherein the first presence server and the second presence server are arranged and configured to communicate presence information regarding client devices of their respective communications domains between each other.

2. The apparatus of claim 1 wherein the first presence server and the second presence server communicate presence information between each other via Session Initiation Protocol (SIP).

3. The apparatus of claim 1 wherein the first presence server and the second presence server are arranged and configured to communicate presence information regarding client devices of their respective communications domains between each other such that presence information regarding a first communications domain client device in the first communications domain is automatically provided to the second presence server via the first presence server.

4. The apparatus of claim 3 wherein presence information regarding a first communications domain client device in the first communications domain is automatically provided to the second presence server via the first presence server in response to a SUBSCRIBE message.

5. The apparatus of claim 3 wherein presence information regarding a first communications domain client device in the first communications domain is automatically provided to the second presence server via the first presence server via at least one Session Initiation Protocol proxy.

6. A method to facilitate inter-domain presence services comprising:
at a first presence server as comprises a part of a first communications domain:
determining a need to source a SUBSCRIBE message;
directing a SUBSCRIBE message to a second presence server as comprises a part of a second communications domain regarding a second communications domain client device.

7. The method of claim 6 wherein directing a SUBSCRIBE message to a second presence server further comprises directing a SUBSCRIBE message to a second presence server using Session Initiation Protocol.

8. The method of claim 6 wherein directing a SUBSCRIBE message to a second presence server further comprises directing a SUBSCRIBE message to a second presence server via a first Session Initiation Protocol server.

9. The method of claim 8 wherein directing a SUBSCRIBE message to a second presence server via a first Session Initiation Protocol server further comprises directing a SUBSCRIBE message to a second presence server via a first Session Initiation Protocol server as comprises a part of the first communication domain.

10. The method of claim 9 wherein directing a SUBSCRIBE message to a second presence server via a first Session Initiation Protocol server as comprises a part of the first communication domain further comprises directing a SUBSCRIBE message to a second presence server via a first Session Initiation Protocol server as comprises a part of the first communication domain and a second Session Initiation Protocol server.

11. The method of claim 10 wherein directing a SUBSCRIBE message to a second presence server via a first Session Initiation Protocol server as comprises a part of the first communication domain and a second Session Initiation Protocol server further comprises directing a SUBSCRIBE message to a second presence server via a first Session Initiation Protocol server as comprises a part of the first communication domain and a second Session Initiation Protocol server as comprises a part of the second communication domain.

12. The method of claim 6 and further comprising:
receiving from the second presence server a NOTIFY message comprising presence information regarding the second communications domain client device.

13. The method of claim 12 and further comprising:
receiving a SUBSCRIBE message from a first communications domain client device regarding the second communications domain client device.

14. The method of claim 13 wherein receiving a SUBSCRIBE message from a first communications domain client device regarding the second communications domain client device further comprises receiving a SUBSCRIBE message from a first communications domain client device regarding the second communications domain client device via a Session Initiation Protocol server.

15. The method of claim 13 and further comprising:
forwarding at least a portion of the NOTIFY message to the first communications domain client device.

16. The method of claim 15 wherein forwarding at least a portion of the NOTIFY message to the first communications domain client device further comprises forwarding at least a portion of the NOTIFY message to the first communications domain client device via a Session Initiation Protocol server.

17. The method of claim 12 and further comprising:
temporarily caching at least a portion of the NOTIFY message to provide cached information regarding presence of the second communication domain client device.

18. The method of claim 17 and further comprising:
automatically clearing the cached information in response to a predetermined event.

19. The method of claim 18 wherein the predetermined event comprises at least one of:
receiving an updated presence communication regarding the second communication domain client device;
detecting expiration of a time window as corresponds to the cached information.

20. The method of claim 6 and further comprising:
using the cached information to respond to a presence inquiry regarding the second communication domain client device.

21. A presence server comprising:
a controller;
a first memory operably coupled to the controller and having presence information regarding local communications domain client devices stored therein;
a second memory operably coupled to the controller and having presence information regarding at least one non-local communications domain client device stored therein.

22. The presence server of claim 21 wherein the presence information regarding at least one non-local communications domain client device further comprises presence information as was received by the presence server from a non-local presence server.

23. The presence server of claim 22 wherein the controller further comprises means for:
directing a SUBSCRIBE message to the non-local presence server as comprises a part of a non-local communications domain regarding the non-local communications domain client device.

24. The presence server of claim 23 wherein the controller further comprises means for:
receiving from the non-local presence server a NOTIFY message comprising presence information regarding the non-local communications domain client device.

25. The presence server of claim 23 wherein the controller further comprises means for:
receiving a SUBSCRIBE message from a local communications domain client device regarding the non-local communications domain client device.

26. The presence server of claim 21 wherein the presence information comprises, at least in part, information as corresponds to a received NOTIFY message.

27. The presence server of claim 21 wherein the controller further comprises means for automatically clearing the presence information in response to a predetermined event.

28. The presence server of claim 27 wherein the predetermined event comprises at least one of:
receiving an updated presence communication regarding the non-local communication domain client device;
detecting expiration of a time window as corresponds to the presence information.

29. The presence server of claim 21 wherein the controller further comprises means for using the presence information to respond to a locally-sourced presence inquiry regarding the non-local communication domain client device.
